(19) United States
(12) Patent Application Publication
(10) Pub. No.: US 2009/0025543 A1
(43) Pub. Date: Jan. 29, 2009

(54) Instant coil system

(76) Inventor: Rick Alan Swartz, Indianapolis, IN (US)

Correspondence Address: RICK ALAN SWARTZ, 3128 W 76TH ST, INDIANAPOLIS, IN, 46268, US

(21) Appl. No.: 12/220,341

(22) Filed: Jul. 24, 2008

Related U.S. Application Data
(60) Provisional application No. 60/961,679, filed on Jul. 24, 2007.

(51) Int. Cl. G10H 3/18; G10H 3/14

(52) U.S. Cl. 84/727; 84/743

(57) ABSTRACT

A box installed in an instrument with a cut out where a pick up coil can be instantly slid in and out or side to side. The coils are slid into the box unit which has a slice in it to allow the coils to be slid side to side along a path of the strings to achieve different tonal effects.

### BACKGROUND OF THE INVENTION

1. Field of the Invention

In general this invention relates to electric stringed instruments having a moveable pick up system with instantly changeable pick up coils.

2. Prior Art

With this invention, an instrument would not have to be taken into a music shop for coil changes. In the past, stringed instruments have had a fixed coil location and were unable to pick up on the full sound in between their coils and would have to be electronically mixed, resulting in phase shifts since the coils simultaneously send out a slightly different wavelength of vibrating strings.

The slideable pick up system has the advantage of more effectively capturing the tonal characteristics of the instrument by being able to control the distance between the pick up coils. This system offers no limits to the range of tonal sounds that can now be achieved simply by properly placing the coils in there location.

Some references: U.S. Pat. No. 3,911,777 Rendell. U.S. Pat. No. 5,012,716 Claudio Pagelli.

### BRIEF SUMMARY OF THE INVENTION

The device I am submitting is a 2 part system. The main box and the coil holder.

Part #1. The main box.

The main box is installed in the instrument body with a cut out section where the coil holders are slid into the box. All the electrical wiring is attached to the box. The cut out section has a hinge on the bottom to flip open to allow you to slide the coils in and out of the instrument.

The length of the main box may vary due to different instrument styles and sizes.

Part #2. The coil holder.

The coil holders have an on and off rocker switch which allows you to turn each coil on or off at any time thereby being able to put as many coils on your instrument as you want and just turn them on or off at your desire.

Once the coil holders are installed they complete the electrical circuit.

You need only one volume control knob and one tone control knob. You will also eliminate the coil switch control and use the rocker switch to turn each coil on and off individually.

### SUMMARY OF THE INVENTION

The object of the invention is to be able to change pick up coils at an instant and to also be able to change the broad spectrum of different tonal effects of the instrument by being able to slide the coils to different locations along the strings path. All this can be achieved at a low cost trouble free and easy to operate system. The present invention is currently installed in an electric guitar.

The present invention includes a main box unit constructed of aluminum sides with copper strips installed in a channel connected to the wiring of the instrument to complete the connection when the coil holders are installed. The box also has a stainless steel bottom but can be exchanged with a wooden one that can be stained or painted to match the looks of the instrument. The pick up coil holder being made of aluminum with a rocker switch installed on it to be able to turn each coil on and off at an instant. There is a cut out section with a hinge on the bottom of it which flips open at an instant to allow the coils to be slid in and out at an instant.

### DESCRIPTION OF THE DRAWINGS

Page 1.

FIG. 1 is the top view of a six string electric guitar with the main box 1 and two coils installed 2 on two coil holders installed 3 in the main box. Even though you can install coils along the entire string path and turn them on or off at an instant with the rocker switches 4 there are just two coil holders installed in this drawing. There is a hinge installed 5 on a section on the bottom of the guitar 6 to allow you to flip it open to reveal a cut out section where the coils can be slid in and out at an instant. There is one volume 7 and one tone control 8.

Page 2.

FIG. 2 is the main box top view with a stainless steel bottom 1 Two sides, a left side 2 and a right side 3. There is a top piece 4. A bottom section 5 with the removable middle section 6 which is attached to the hinge section on FIG. 1 of page 1.

Page 3.

FIG. 3 is the right side view of the main box. FIG. 4 is the left side view of the main box. FIG. 5 is the side view of the top section of the main box. FIG. 6 is the side view of the bottom section of the main box. FIG. 7 is the side view of the plastic separator strip with copper strip installed. FIG. 8 is the side view of the copper strip.

Page 4.

FIG. 9 is the main box top front inside view 1 showing channel cut out where coil holders slide into it. FIG. 10 is the main box bottom inside front view 1 showing channel cut out where coil holders slide into it.

Page 5.

FIG. 11 shows the main frame of the dual coil holder. 1 shows the wires running through the grooves. 2 shows the cut out section where the coils are to be installed. 3 shows the cut out section where the rocker switch is to be installed. 4 shows the copper strip on the coil holder frame. 5 shows the mounting screws for the copper strips. 6 shows the mounting screws for the plastic separator. 7 shows the plastic separator installed on the coil holder. 8 shows the grooves cut out in the bottom of the single coil holder where the wires are run to the copper strips to complete the connections with the main box.

Page 6

FIG. 13 shows how the coils and the main box are wired and how the connections are met. 1 is showing the two copper strips installed inside the top and bottom sections of the main box. 2 is showing where the wires are connected to the two copper strips.

Page 7

FIG. 14 is showing the top view of a single pick up coil holder with the rocker switch and a pick up coil installed on the holder frame.

FIG. 15 is showing the side view of a pick up coil holder with the rocker switch and a pick up coil installed on the holder frame.

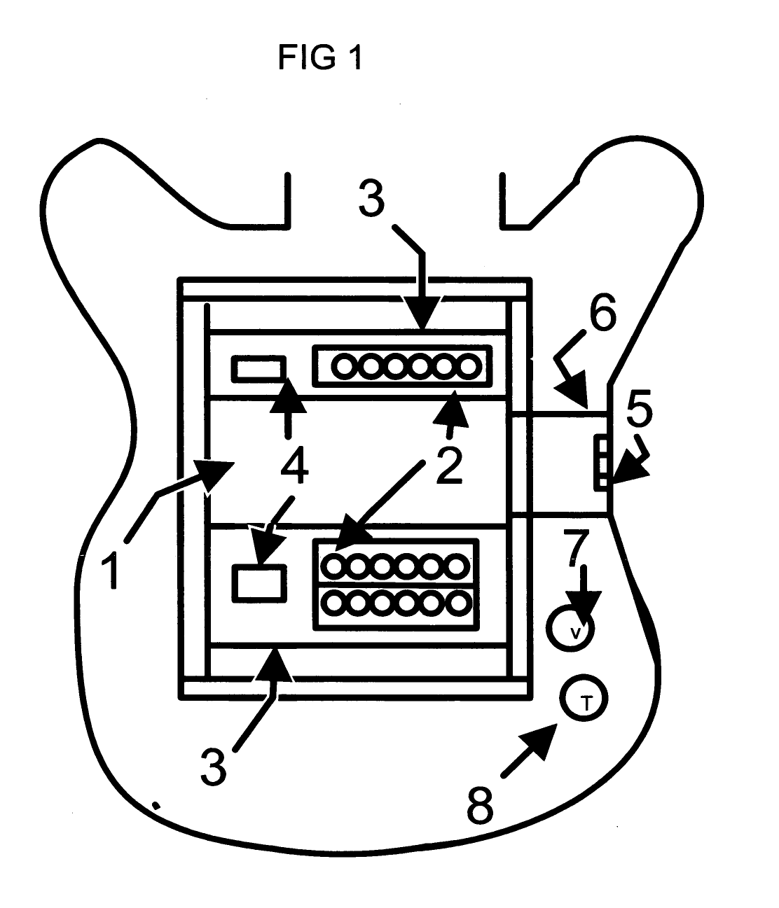

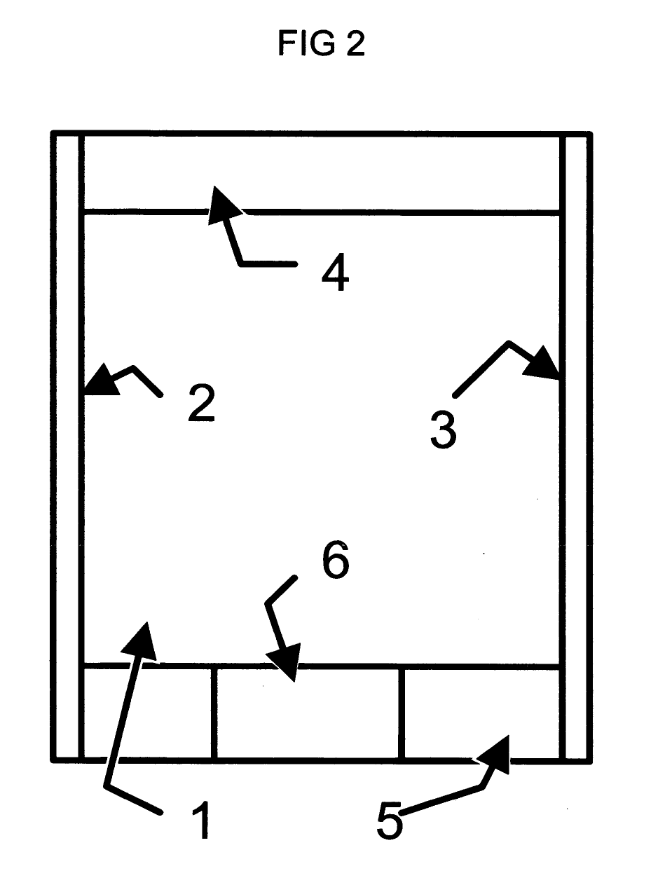

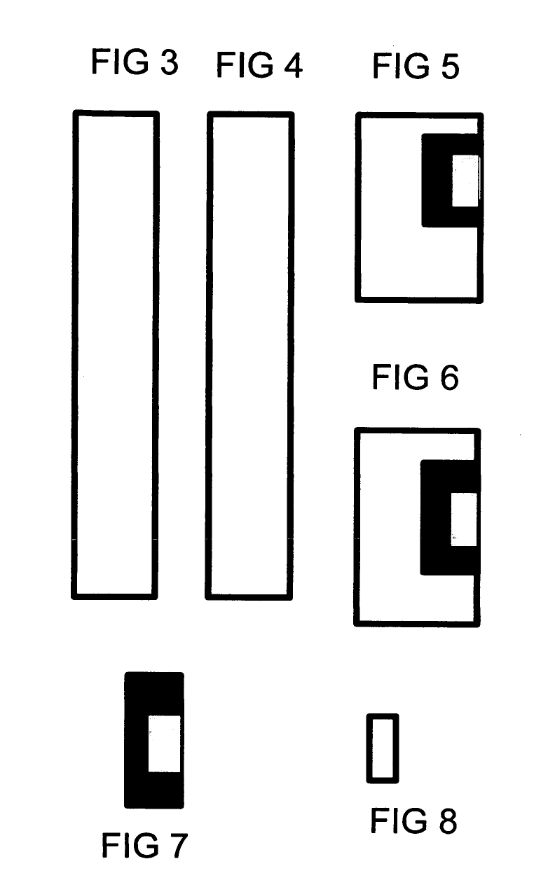

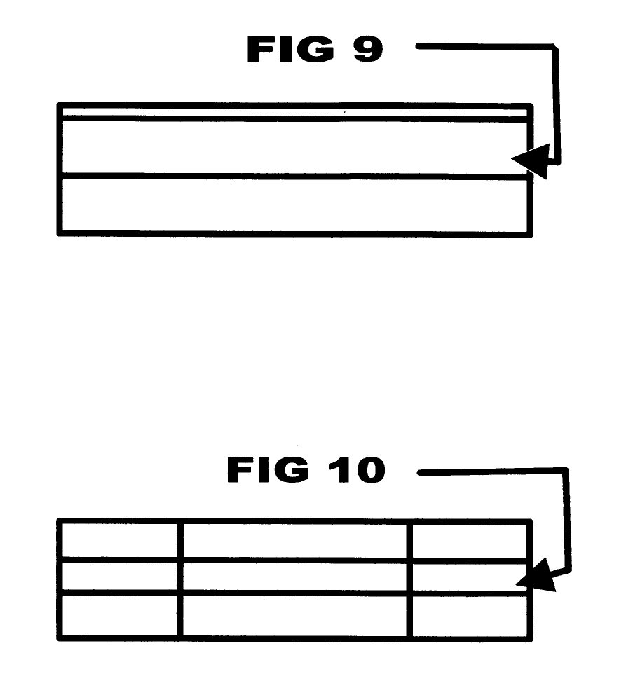

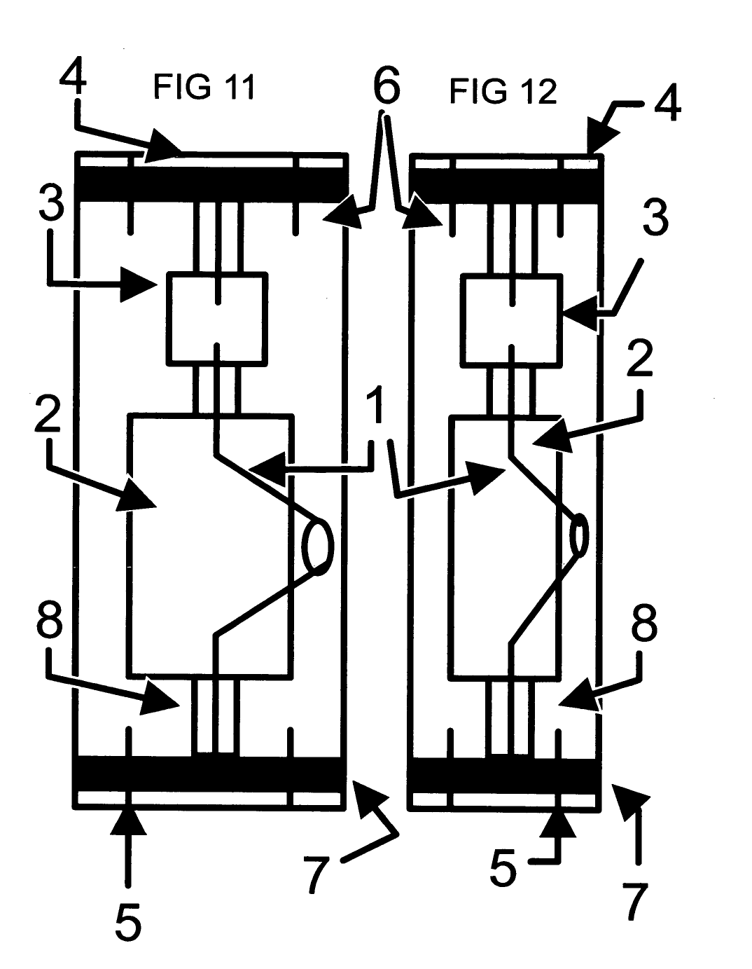

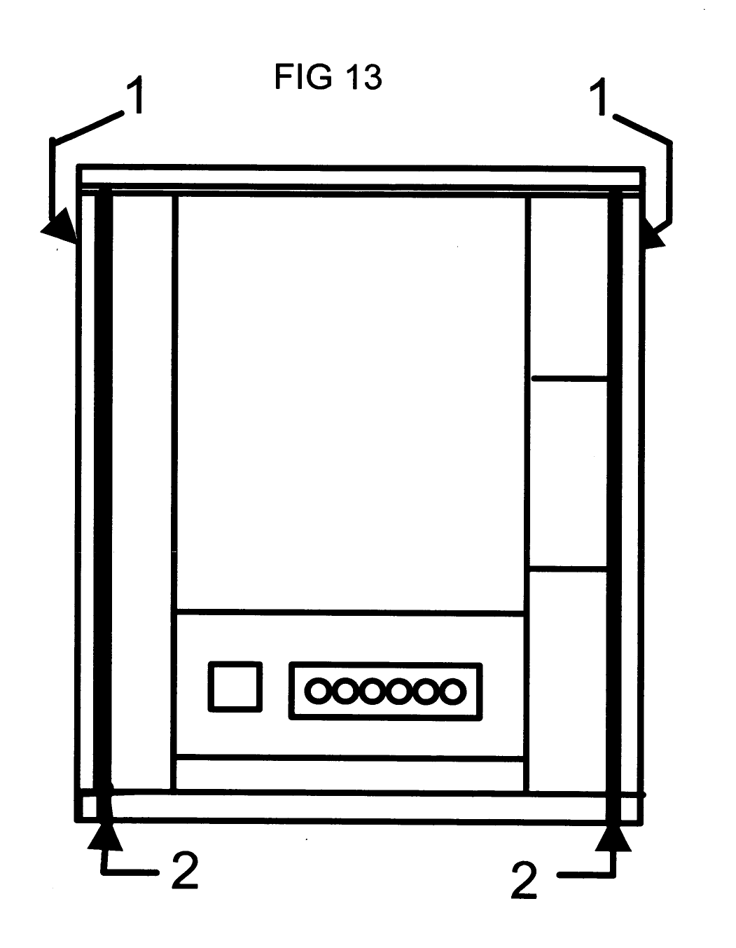

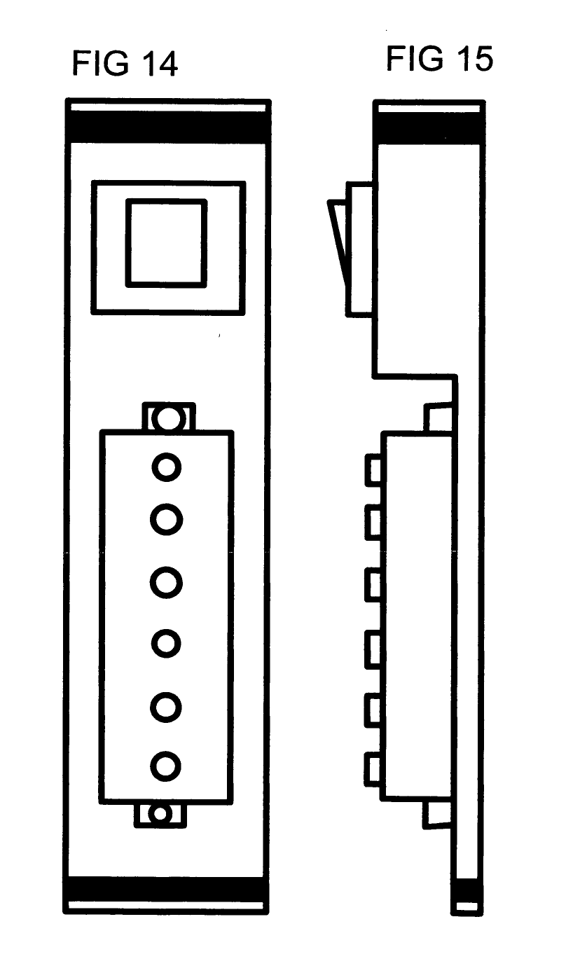

1. I claim that this invention can make instrument pick up coils interchangeable at an instant without having to remove the strings. A person can also slide the coils side to side to instantly change the sound of the instrument.
